(19) United States
(12) Patent Application Publication
(10) Pub. No.: US 2012/0090513 A1
(43) Pub. Date: Apr. 19, 2012

(54) Table/bar stool/ flagpole combination kit to attach to vehicle's trailer hitch

(76) Inventor: Kenneth Wayne Mesker, Evansville, IN (US)

(21) Appl. No.: 12/925,186

(22) Filed: Oct. 15, 2010

(51) Int. Cl. A47B 37/00; G09F 17/00

(52) U.S. Cl. 108/44; 116/173

(57) ABSTRACT

The present invention discloses a table/bar stool/flagpole combination kit to attach to vehicles' trailer hitches for use while tailgating, comprising of a trailer hitch extension; an adjustable support stand; a frame with a plurality of arms extending to preferred boundaries and terminating in a holder with a first aperture and said frame having at least one second aperture; a plurality of seats comprised of a horizontal platform and vertical post which fits through the holder's first aperture and extends to the surface; a table comprising a top with a preferred boundary and at least two legs attached thereto, said legs fitting through apertures in the frame to extend to the surface; and a flag pole, preferably comprised of at least two sections of telescopically fitting pipe, that extends through aligned apertures in the table top and frame, extending to the surface. All vertical supports tighten by locking screws.

### CROSS REFERENCES TO RELATED APPLICATIONS

none.

### STATEMENT AS TO RIGHTS TO INVENTIONS MADE UNDER FEDERALLY SPONSORED RESEARCH AND DEVELOPMENT

Not Applicable

### BACKGROUND OF THE INVENTION

1. Field of the Invention

This invention relates to a table/bar stool/flagpole combination kit to attach to a vehicle's trailer hitch comprising of a frame with a plurality of arms, a trailer hitch extension to connect the frame to the trailer hitch receiver, an adjustable support stand, a plurality of seats, a table, and a flagpole for use when tailgating.

2. Background Information

In the United States today, tailgating parties, or social events held on or around the open tailgate of a vehicle, have become so popular that they have spread from pre-game festivities at football games to both pre- and post-game festivities for other sporting events and for non-sporting events alike. Tailgating often involves consuming beverages and grilling food, and since tailgating often occurs in parking lots at arenas and other locations, those individuals tailgating need places to sit, eat, sit food and beverages, and enjoy themselves while showing their pride for their favorite team. Thus, there is a need for a table/bar stool/flagpole combination kit to attach to a vehicle's trailer hitch for use while tailgating.

A prior art search uncovered the following prior art:

| | | |
|---|---|---|
| U.S. patent Pub. No. 20050241546 | Nov. 3, 2005 | Royse |
| U.S. Pat. No. 5,857,741 | Jan. 12, 1999 | Anderson |
| U.S. Pat. No. 5,950,617 | Sep. 14, 1999 | Lorenz |
| U.S. Pat. No. 6,314,891 | Nov. 13, 2001 | Larson |
| U.S. Pat. No. 6,336,413 | Jan. 8, 2002 | Ball |
| U.S. Pat. No. D593,760 | Jun. 9, 2009 | Fidler |
| U.S. patent Pub. No. 20060053667 | Mar. 16, 2006 | Anderson |
| U.S. patent Pub. No. 20030094473 | May 22, 2003 | Moore |
| U.S. patent Pub. No. 20100101479 | Apr. 29, 2010 | Grahl |

However, none of the above-referenced registrations apply to tables and seats that are bar height which allows for eye-to-eye contact with people sitting and those standing. Additionally, although the above-referenced registrations require attachment to a trailer hitch for transportation, none of the above-referenced registrations necessarily require attachment to a trailer hitch for stability due to the above-referenced registrations relatively low table heights. Finally, none of the above-referenced registrations break down quickly and easily into their component parts to store within the dimensions of the table top for easy storage.

As will be seen from the subsequent description, the preferred embodiments of the present invention overcome the above problems and difficulties of the prior art.

### SUMMARY OF THE INVENTION

Tailgating parties have become so popular that they have spread from pre-game festivities at football games to both pre- and post-game festivities for other sporting events and for non-sporting events alike. Since tailgating often involves consuming beverages and grilling food and occurs in parking lots at arenas and other locations, individuals tailgating need places to sit, eat, sit food and beverages, and enjoy themselves while showing their pride for their favorite team.

The present invention relates to a table/bar stool/flagpole combination kit to attach to a vehicle's trailer hitch for use while tailgating, comprising of a trailer hitch extension; an adjustable support stand; a frame with a plurality of arms extending to preferred boundaries and terminating in a holder with a first aperture there through and with said frame having at least one second aperture; a plurality of seats; a table; and a flag pole. The frame, holders, vertical posts, legs, and pole are preferably made of metal pipe while the horizontal platforms of the seats and the table top are preferably comprised of wood. The preferred embodiment includes a trailer hitch extension which connects the frame to the trailer hitch receiver with said trailer hitch extension having an adjustable support stand for stress reduction on the frame, greater support and stability of the kit, and for adjustment to heights of various receivers. The frame has a plurality of arms, preferably five with each arm having a preferred length, and which the arms extending to preferred boundaries and terminating in a holder with a first aperture. The frame additionally has at least one second aperture through it. The plurality of seats each have a horizontal platform and a vertical post attached thereto, with the vertical post adapted to fit through the first aperture of the holder and make contact with the surface. The table top has a periphery circumscribed to a preferred boundary and with a preferred embodiment of two legs attached to the table top, with said legs being adapted to fit through apertures in the frame and make contact with the ground. There is a preferred aperture through the center of the frame and a preferred aperture though the center of the table top which both align. A pole, preferably comprised of at least two sections of pipe that fit telescopically together and to which a flag can be attached, has been adapted to fit through the aligned apertures in the table top and frame and make contact with the surface.

The preferred height of the horizontal platforms allows for eye-to-eye contact with people sitting on the horizontal platforms next to those standing. The table top's preferred height is a result of the preferred height of the horizontal platforms. As a result of the table top's preferred dimensions, the entire kit, which breaks down quickly and easily, can be stored within the table top dimensions for easy transportation and storage. All vertical supports extend to the ground and are able to be tightened into place by locking screws, providing for greater stability, support, and weight distribution of the kit.

### BRIEF DESCRIPTION OF THE DRAWINGS

FIG. 1a illustrates the top view of the present invention, table/bar stool/flagpole combination kit to attach to a vehicle's trailer hitch.

FIG. 1b illustrates the front view of the table and bar stools, focusing on the preferred height of the table and bar stools.

FIG. 2 illustrates the side view of the present invention focusing on the trailer hitch extension to connect the frame to the trailer hitch, the adjustable support stand, and the frame while illustrating that the legs extend through the frame to the ground and that the pole extends through apertures in the table top and the frame which are aligned and where it can be tightened before extending to the surface.

FIG. 3a illustrates the present invention showing the entire apparatus when assembled.

FIG. 3b1 illustrates a top view of the present invention when broken down into its component parts and stored within the dimensions of the table top.

FIG. 3b2 illustrates a side view of the present invention when broken down into its component parts and stored within the dimensions of the table top.

### DESCRIPTION OF THE PREFERRED EMBODIMENTS

In accordance with the present invention, a table/bar stool/flagpole combination kit to attach to a vehicle's trailer hitch is disclosed. Said table/bar stool/flagpole combination kit is directed to enable individuals tailgating to sit down, have a place to either sit or stand to eat and drink or to sit food and beverages on, and show their pride for their favorite team.

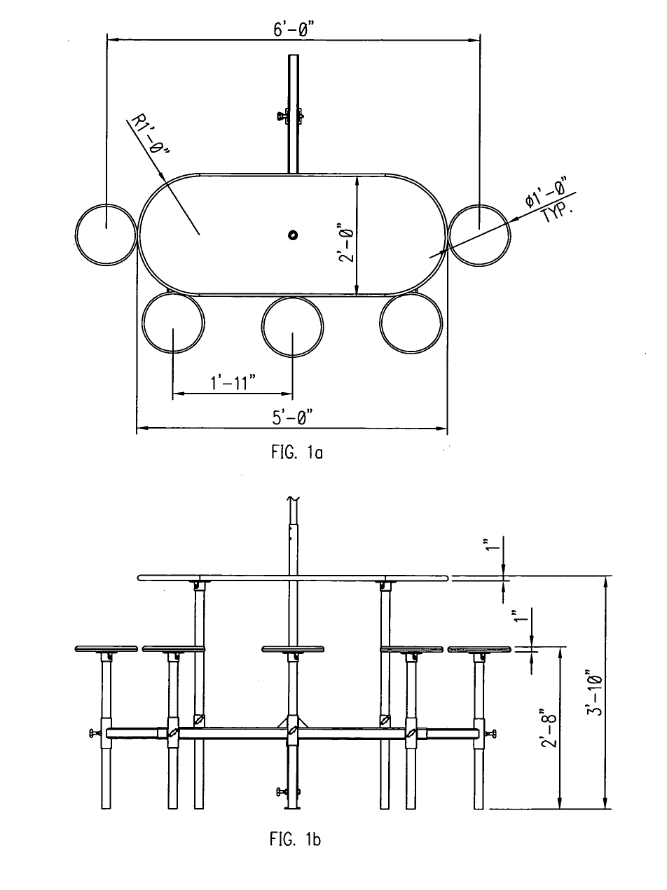

FIG. 1a illustrates the preferred embodiment of the table/bar stool/flagpole combination kit to attach to a vehicle's trailer hitch. The kit generally includes a trailer hitch extension; an adjustable support stand; a frame with a plurality of arms extending to a preferred boundary and terminating in a holder with a first aperture there through and with said frame having at least one second aperture; a plurality of seats; a table; and a flag pole. The frame, the holder, the vertical post, the legs, and the pole are preferably comprised of metal pipe while the horizontal platforms of the seats and the table top are preferably comprised of wood.

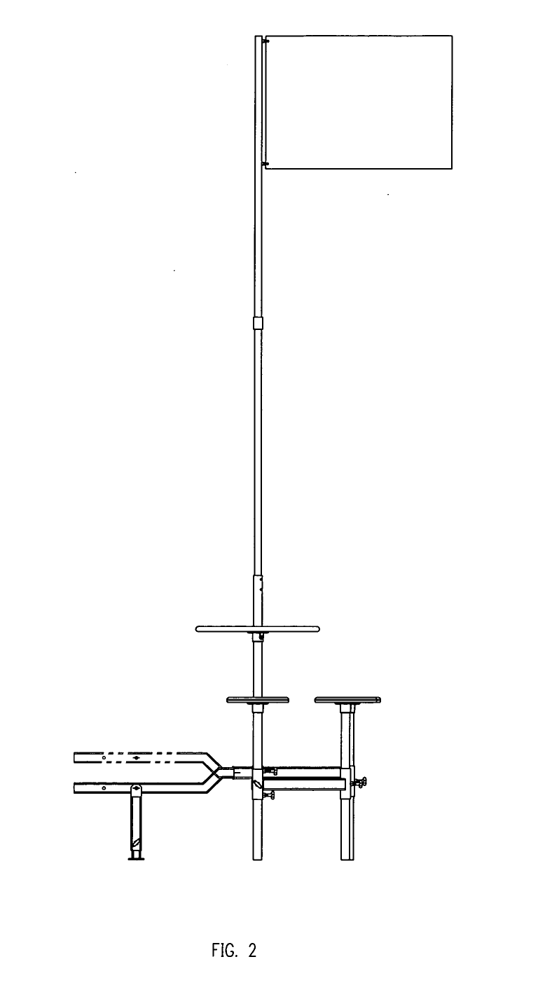

The trailer hitch extension is preferably comprised of a metal substance. As shown in FIG. 2, the trailer hitch extension connects the frame to the trailer hitch receiver and maintains the frame at a preferred elevation which can adjust to various heights of receivers on cars, vans, SUVs, and trucks. Said trailer hitch extension also contains an adjustable support stand under the hitch receiver which allows for less stress on the frame, greater stability of the kit, and adjustments to various heights of receivers on cars, vans, SUVs, and trucks.

FIGS. 1b, 2, and 3a illustrate the frame, comprised of metal pipe, which has a plurality of arms which extend to preferred boundaries and terminate in a holder, which has a locking screw. The preferred embodiment has five arms, with two long arms and three short arms. Said long arms extend opposite from each other to a preferred boundary of 36 inches from the center of the frame to the holder. Said three short arms extend outwards on the side opposite of the trailer hitch extension and parallel to each other, with the two outside short arms having preferred boundaries of 17 inches and the one inside short arm having a preferred boundary of 18 inches, causing these arms to have offset preferred boundaries in an arc-like shape. Each arm terminates in a holder with a first aperture there through. Additionally, the frame has at least one second aperture there through.

FIGS. 1a, 1b, 2, and 3a illustrates the plurality of seats, each with a horizontal platform and a vertical post attached thereto, with the vertical post adapted to fit through the first aperture of the holder and then to make contact with the surface to support the horizontal platform. Said vertical posts are adjustable for various trailer hitch heights and unstable surfaces. Said vertical posts are tightened into place by the locking screws in the holder which results in extra stability. The horizontal platform has a height greater than 30 inches, with a preferred height of 32 inches from the top of the horizontal platform to the surface. Said preferred height of the horizontal platform allows for eye-to-eye contact with people sitting on said horizontal platforms next to those individuals standing.

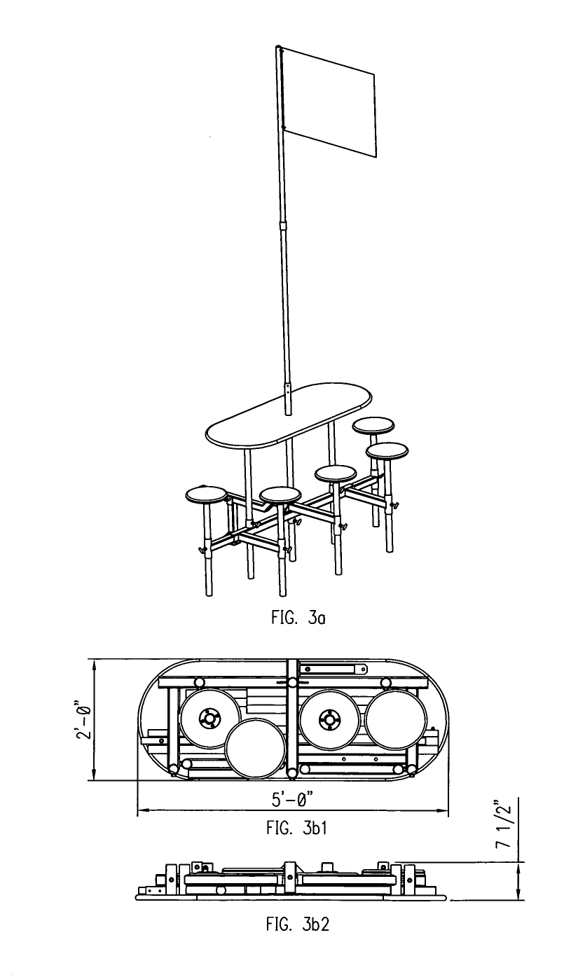

FIGS. 1a and 3a also illustrate a table having a table top with a periphery circumscribed to the preferred boundary and with a preferred embodiment of two legs attached thereto. Said legs are adapted to fit through apertures in the frame and make contact with the surface to support the table top above the plurality of seats, allow for greater weight distribution of the kit, and allow for great stability. Locking screws, as shown in FIG. 1b, are adapted to fit through the frame and tighten said leg to secure it into place and allow for greater stability.

Said table top has a height of 40 inches or higher, with a preferred height of 46 inches from the top of the table top to the surface. Said preferred height of the table top is a result of the preferred height of the horizontal platforms on said seats.

Said table top has a preferred dimension of 24 inches by 60 inches. This dimension is preferred as it allows the entire kit when broken down to be stored within the dimensions of the table top for easy transportation and storage as shown in FIGS. 3b1 and 3b2.

There is a preferred aperture though the center of the frame and a preferred aperture through the center of the table top which positions to align with the aperture through the center of the frame. As can be seen in FIG. 32, a pole, which is preferred to be comprised of at least two sections of pipe that fit together telescopically and to which a flag can be attached, has been adapted to fit through the aperture in the center of the table top and then through the aligned aperture in the frame to extend to the surface. Upon extending through the aperture in the frame, locking screw can tightened down upon and hold said pole into place. Said pole provides an additional point of impact with the surface for support, stability, and weight distribution of the kit.

The entire table/bar stool/flagpole combination kit to attach to a vehicle's trailer breaks down into its components easily and quickly and as mentioned above can be stored within the dimensions of the table top as shown in FIGS. 3b1 and 3b2. Finally, as mentioned above and can be seen in FIG. 1b, all vertical supports are tightened by locking screws for extra stability and support, and they allow the kit to be user friendly to uneven ground surface.

An alternative embodiment of the kit can result if the pole is not used or some of the plurality of seats is not used.

Although the description above contains many specifications, these should not be construed as limiting the scope of the invention but as merely providing illustrations of some of the presently preferred embodiments of this invention.

I claim:

1. A tailgate kit for a vehicle resting on a surface and having a trailer hitch, comprising:
a frame having a plurality of arms extending to a preferred boundary, each arm terminating in a holder with a first aperture there through, the frame additionally having at least one second aperture there through;
a trailer hitch extension adapted to connect the frame to the trailer hitch and maintain the frame at a preferred elevation;
The tailgate kit of claim 1, further comprising of an adjustable support stand attached to the trailer hitch extension;
a plurality of seats each having a horizontal platform and a vertical post attached thereto, the vertical post adapted to fit through the first aperture and make contract with the surface to support the horizontal platform; and
a table having a table top with a periphery circumscribed by the preferred boundary and at least one leg attached thereto, the leg adapted to fit through the at least one second aperture and make contact with the surface to support the table top above the plurality of seats;
whereas, the preferred elevation braces the seats and the table.

2. The tailgate kit of claim 1, further comprising of at least one third aperture in the frame, at least one fourth aperture through the table top positioned to align with the at least one third aperture, and a pole adapted to fit through the at least one fourth aperture and the aligned at least one third aperture to rest vertically on the frame.

3. The tailgate kit of claim 2, wherein the pole is comprised of at least two sections fitting together telescopically.

4. The tailgate kit of claim 2, further comprising a flag at the end of the pole.

5. The tailgate kit of claim 1, wherein the frame, the holder, the vertical post and the leg are comprised of pipe.

6. The tailgate kit of claim 1, wherein the preferred boundary is ovate in shape.

7. The tailgate kit of claim 1, wherein locking screws are inserted through the holder of each arm, the at least one third aperture through the frame, and the at least one second aperture for support and stability of the tailgate kit.
